(19) United States
(12) Patent Application Publication
(10) Pub. No.: US 2025/0202298 A1
(43) Pub. Date: Jun. 19, 2025

(54) ELECTRIC MOTOR WITH SEGMENTED LAMINATED ROTOR SECTIONS AND METHOD OF MANUFACTURE

(71) Applicant: DRS Naval Power Systems, Inc., Milwaukee, WI (US)

(72) Inventors: Edgar S. Thaxton, Groton, MA (US); Gregory Cervenka, Houston, TX (US); James P. Koniers, Red Lion, PA (US); Artur Ponikiewski, Woburn, MA (US); Elizabeth Kupcinskas, Ashburnham, MA (US)

(73) Assignee: DRS Naval Power Systems, Inc., Milwaukee, WI (US)

(21) Appl. No.: 18/980,113

(22) Filed: Dec. 13, 2024

Related U.S. Application Data
(60) Provisional application No. 63/609,731, filed on Dec. 13, 2023.

(51) Int. Cl. H02K 1/276; H02K 1/02; H02K 1/24

(52) U.S. Cl. CPC H02K 1/276; H02K 1/02; H02K 1/24

(57) ABSTRACT

A rotor rim structure includes a plurality of structural segments. Each structural segment has a curved profile and is stacked in a substantially parallel arrangement to form a structurally integrated hoop structure. The rotor rim structure also includes a permanent magnet retained in a salient pole configuration and a tie bar extending axially through each structural segment of the plurality of structural segments. The plurality of structural segments can include a first structural segment disposed in a first plane and comprising a first cavity, a second structural segment positioned adjacent to the first structural segment in the first plane, and a third structural segment positioned in a second plane parallel to the first plane. The third structural segment is circumferentially offset from the first structural segment and the second structural segment and the third structural segment includes a second cavity aligned with the first cavity.

### CROSS-REFERENCES TO RELATED APPLICATIONS

This application claims priority to U.S. Provisional Patent Application No. 63/609,731, filed on Dec. 13, 2023, entitled “Electric Motor with Segmented Laminated Rotor Sections and Method of Manufacture,” the disclosure of which is hereby incorporated by reference in its entirety for all purposes.

### BACKGROUND OF THE INVENTION

Large, direct drive electric motors (e.g., motors used in marine propulsion and mud pumps for oil drilling operations) can require very large, precision machined fabricated/cast rotor rims that are challenging to produce. Despite the progress made in the area of large, direct drive electric motors, there is a need in the art for improvements in this area.

### SUMMARY OF THE INVENTION

Embodiments of the present invention relate to electric machines, more specifically to rotor rim structures of electromagnetic machines. More particularly, embodiments of the present invention relate to segmented and laminated rotor rim structures for large, direct drive electric motors, which can also be referred to as electromagnetic machines. By overlapping a plurality of structural segments circumferentially, embodiments of the present invention increase or remove the diameter limit for rotor manufacture typically caused by machine tool limits.

Numerous benefits are achieved by way of the present disclosure over conventional techniques. For example, embodiments of the present invention provide a rotor for use in an electric machine that uses stamped laminations in the mechanical portion of the rotor. In contrast with conventional designs that rely on precision machining to form the mechanical portions of the rotor, embodiments of the present invention reduce manufacturing complexity and cost. Moreover, brick-laid laminations can provide larger rotor diameters than available using conventional machined rotors. These and other embodiments of the disclosure, along with many of its advantages and features, are described in more detail in conjunction with the text below and corresponding figures.

### BRIEF DESCRIPTION OF THE DRAWINGS

The included drawings are for illustrative purposes and serve only to provide examples of possible structures and arrangements for the disclosed inventive apparatuses and methods for segmented laminated rotor sections. These drawings in no way limit any changes in form and detail that may be made to the disclosure by one skilled in the art without departing from the spirit and scope of the disclosure. The embodiments will be readily understood by the following detailed description in conjunction with the accompanying drawings, wherein like reference numerals designate like structural elements, and in which:

FIG. 1 illustrates an exemplary rotor rim structure with laminated structural segments according to an embodiment of the present disclosure.

FIG. 2 illustrates a cross-sectional view of an exemplary rotor rim structure with laminated structural segments according to an embodiment of the present disclosure.

FIG. 3 illustrates a zoomed-in view of an exemplary rotor rim structure with laminated structural segments according to an embodiment of the present disclosure. FIG. 4 illustrates an exploded view of an exemplary plurality of structural segments for

a rotor rim structure according to an embodiment of the present disclosure.

FIG. 5 illustrates an exploded view of an exemplary structural segment, rim segment, and cap segments for a rotor rim structure according to an embodiment of the present disclosure.

FIG. 6 illustrates a plan view of an exemplary permanent magnet installed within a rotor rim structure according to an embodiment of the present disclosure.

FIG. 7 illustrates a cross-sectional view of an exemplary rotor rim structure with laminated segments and permanent magnets according to an embodiment of the present disclosure.

FIGS. 8A-8C illustrate exemplary installation of a permanent magnet into a rotor rim structure with laminated segments according to an embodiment of the present disclosure.

FIG. 9 illustrates a zoomed-in, plan view of an exemplary portion of a rim segment and a cap segment with wedge bars according to an embodiment of the present disclosure.

FIG. 10 illustrates a zoomed-in, plan view of an exemplary portion of a rim segment and a cap segment with wedge bars and tee bars according to an embodiment of the present disclosure.

FIG. 11 illustrates a zoomed-in, perspective view of an exemplary portion of a rim segment and a cap segment with wedge bars according to an embodiment of the present disclosure.

FIG. 12 is a simplified exploded view of an electromagnetic machine including a rotor rim structure with laminated structural segments according to an embodiment of the present invention.

### DETAILED DESCRIPTION OF THE INVENTION

The following detailed description of example implementations refers to the accompanying drawings. The same reference numbers in different drawings may identify the same or similar elements.

The disclosure generally applies to the field of electric machines, more specifically to rotor rim structures of electromagnetic machines. Typically, rotors for large electromagnetic machines with permanent magnets have rims that are fabricated and/or cast as a singular hoop structure. These single-structure rotor rims can be difficult to precisely manufacture for large rotors. The apparatus, system, and techniques described herein allow rotor rim structures to be manufactured for large, low-speed (e.g., less than 500 RPM) direct-drive electric motors such as marine propulsion engines and mud pumps utilizing laminated segments. Instead of fabricating a singular hoop structure, structural segments can be stacked in a substantially parallel arrangement to form a structurally integrated hoop structure. In an example, three structural segments that each have an arc of 120° can form a single layer of the rotor rim structure. A second layer of the rotor rim structure made of three additional structural segments can be laid atop the first layer. The structural segments in the second layer may be circumferentially offset, such that the seam between two adjacent structural segments in the second layer does not align with any seams between adjacent structural segments in the first layer. The stacked layers of structural segments can be axially retained via tie bars to form a structurally integrated hoop structure for the rotor.

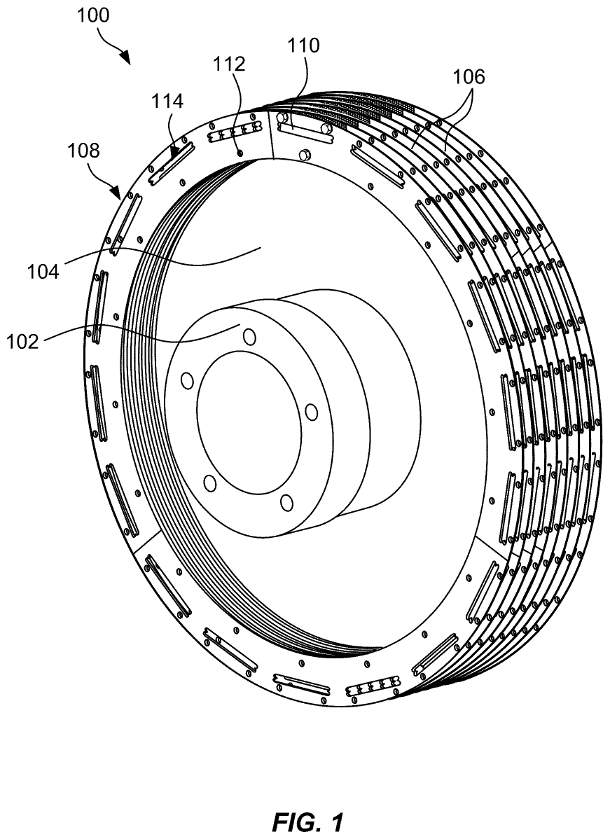

FIG. 1 illustrates an exemplary rotor rim structure 100 with laminated structural segments 106 according to an embodiment of the present disclosure. The rotor rim structure 100 can be a non-continuous, structurally integrated hoop structure 108 that is formed of a plurality of structural segments 106 that are stacked in a brick-laid pattern. The plurality of structural segments 106 can be connected to a center plate 104 and hub 102. In some examples, rotor webs connected to the hub 102 can be used to clamp the plurality of structural segments 106 on the ends or the middle of the rotor rim structure 100. Each of the plurality of structural segments 106 can have a curved profile that can allow multiple (e.g., three) structural segments to be arranged in a plane to create a hoop. The plurality of structural segments 106 can be stacked in a substantially parallel arrangement to form the structurally integrated hoop structure 108.

Although two layers of three structural segments 106 are illustrated in embodiments described herein, this is not required and the number of structural segments and the number of layers of structural segments can be more or less than two layers of structural lamination or three structural segments depending on the particular application, for example, based on overall rotor diameter and length, speed, and the like. Merely by way of example, in some embodiments, three circumferentially offset laminations are utilized for a given layer. However, this is not required. For instance, for some implementations, particular large diameter rotors, the number of circumferentially offset laminations could be more than three structural segments, for example, as many as 10 or more laminations per layer.

Each structural segment of the plurality of structural segments 106 can include cavities 114 that align axially through the stacked structural segments 106. A permanent magnet 110 (e.g., rare-earth permanent magnets) can be retained in the aligned cavities 114. The rotor rim structure 100 can be held together by axially threaded tie bars 112 that can compress the stack of the plurality of structural segments 106. In the illustrated embodiment, axially threaded tie bars 112 act as a “pole retainer,” but they also provide a load path to axially compress the lamination stack to a predetermined level of compression in order to contribute to the overall structural integrity of the laminated rim section.

In other embodiments, a straight bar that is welded into place once the stack is compressed could be utilized. Alternatively, a fluted dowel can be driven through the rotor rim structure 100 to axially hold the stack of the plurality of structural segments 106. Thus, in addition to threaded tie bars, other structures can be used that extend the length of the stack and facilitate the compression of the stack, including structures that may or may not be fluted or otherwise configured in a manner to prevent relative motion between subsequent layers of laminations. Knurls on the structure can achieve this function. Also, having tabs on the lamination that are “plowed over” as the “pole retainer” is axially inserted into the stack can achieve the same function.

By overlapping the plurality of structural segments 106 circumferentially and constraining the plurality of structural segments 106 with highly preloaded axial threaded tie bars 112, the rotor rim structure 100 can become sufficiently rigid for use as a rotor inside a motor of an electromagnetic machine. The segmentation can remove the diameter limit for rotor manufacture typically caused by machine tool limits.

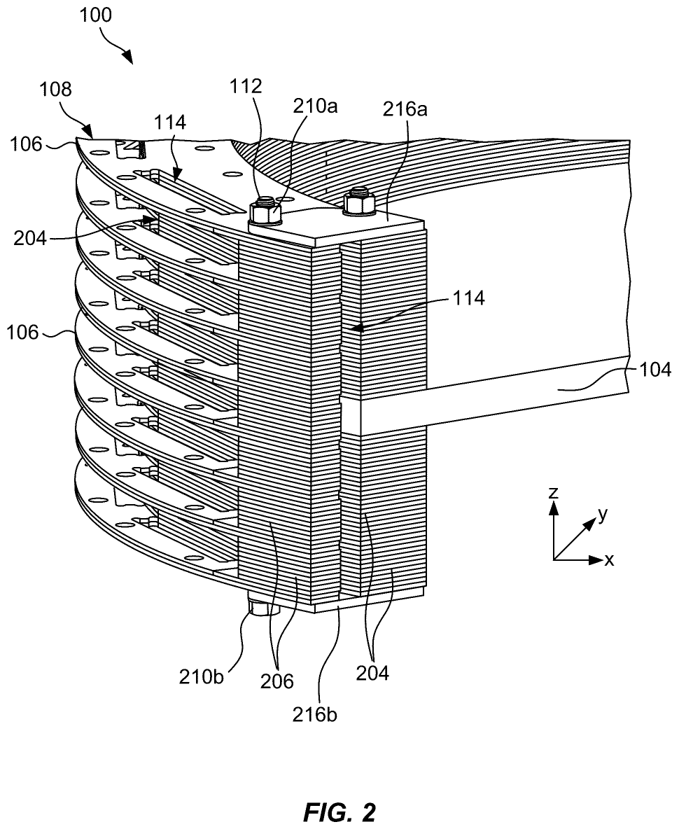

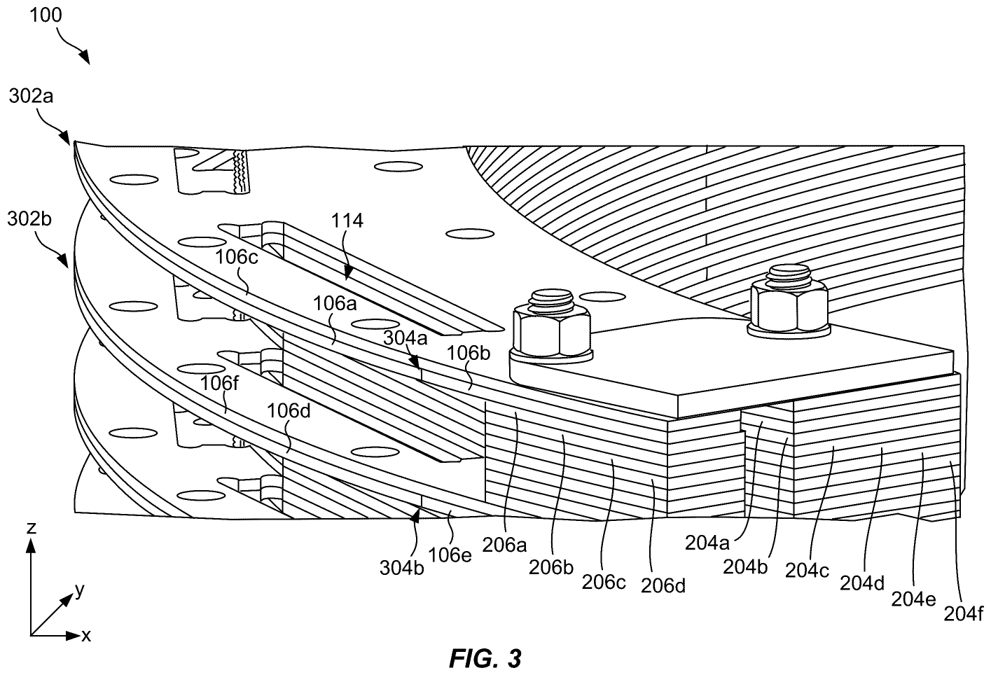

FIG. 2 illustrates a cross-sectional view of an exemplary rotor rim structure 100 with laminated structural segments according to an embodiment of the present disclosure. The permanent magnets 110, which are placed in cavities 114, are removed from the image for clarity. The structurally integrated hoop structure 108 formed by structural segments can include multiple types of segments that are stacked in sets. For example, a set of a plurality of structural segments 106 can be stacked. A layer of the plurality of structural segments 106 stacked on top of another layer of plurality of structural segments 106 in this set may be circumferentially offset. This is depicted in further detail in FIG. 3. Still referring to FIG. 2, the plurality of structural segments 106 may include cavities 114 that can axially align when stacked. As mentioned above, a permanent magnet (not pictured) can be retained within these axially aligned cavities 114.

After forming a set of the plurality of structural segments 106, sets of a plurality of rim segments 204 and a plurality of cap segments 206 can be stacked atop the set of plurality of structural segments 106. Cap segments 206 can also be referred to as end segments or peripheral segments to indicate the structural element disposed between sets of a plurality of structural segments 106. The plurality of structural segments 106, the plurality of rim segments 204, and the plurality of cap segments 206 can be constructed via laser cutting, stamping, or other suitable method. The plurality of rim segments 204 and plurality of cap segments 206 may be smaller in size than the plurality of structural segments 106.

In order to form the rotor rim structure 100, the following stacking arrangement can be used. A plurality of structural segments 106 are positioned in a plane. A plurality of rim segments 204 and a plurality of cap segments 206 are then placed atop the plurality of structural segments 106. This process then repeats, positioning another plurality of structural segments 106, a plurality of rim segments 204, and a plurality of cap segments 206. This process can be repeated, positioning a final plurality of structural segments 106 on the last plurality of rim segments 204 and plurality of cap segments 206. After completion of the process, the sets of segments that have been stacked will create the structurally integrated hoop structure 108. FIG. 2 depicts seven sets making up the plurality of structural segments 106, the plurality of rim segments 204, and the plurality of cap segments 206, and a final plurality of structural segments 106, but any number of sets may be used.

A set of the plurality of rim segments 204 and a set of the plurality of cap segments 206 can be spaced at a radial distance from one another atop a set of the plurality of structural segments 106. This spacing between the plurality of rim segments 204 and the plurality of cap segments 206 can align with the cavities 114 of the plurality of structural segments 106. Thus, permanent magnets can be retained within the plurality of structural segments 106 and between the plurality of rim segments 204 and the plurality of cap segments 206. First end cap 216a and second end cap 216b can be fastened to the structurally integrated hoop structure 108 to axially retain the plurality of structural segments 106, the plurality of rim segments 204, and the plurality of cap segments 206 as well as permanent magnets in the rotor rim structure 100. For example, first end cap 216a can be fastened to a first end of the structurally integrated hoop structure 108. Second end cap 216b can be fastened to a second end of the structurally integrated hoop structure 108. First end cap 216a and second end cap 216b can distribute compression and loading of tie bars 112.

For example, tie bars 112 can extend through the plurality of structural segments 106, plurality of rim segments 204, plurality of cap segments 206, and first end cap 216a and second end cap 216b to fasten the structurally integrated hoop structure 108 together. A tie bar 112 can have a first fastener 210a attached on a first end of the tie bar 112 and a second fastener 210b attached on a second end of the tie bar 112 to axially couple the segments together on the tie bar 112. In some examples, first fastener 210a and second fastener 210b can be hex head cap screws and hex nuts.

In some embodiments, the plurality of structural segments 106 can be fabricated using a stainless steel material (e.g., 200 series stainless steel), aluminum, or other non-ferromagnetic material that provides sufficient structural integrity. The plurality of rim segments 204 and the plurality of cap segments 206 can be a ferromagnetic material such as a carbon steel material. In some embodiments, the coefficient of thermal expansion (CTE) of the plurality of structural segments 106 is substantially equal to the CTE of the plurality of rim segments 204 and the plurality of cap segments 206, thereby preventing thermal mismatch between components as the rotor rim structure increases in temperature during operation.

Depending on the particular implementation, the ratio of structural segments 106 to rim segments 204 and cap segments 206 can be selected such that 90% of the axial length is made up of ferromagnetic material. In some embodiments, first end cap 216a and second end cap 216b may be made of a stainless steel material and the center plate 104 may be made of a carbon steel material. The carbon steel material can provide a high permeability material that can carry flux from permanent magnets installed within the structurally integrated hoop structure 108 and from a stator coupled to the rotor rim structure 100. The stainless steel material can provide a low permeability material that can physically constrain the permanent magnets against centrifugal forces without interrupting the magnetic flux. As will be evident to one of skill in the art, the low permeability laminations do not carry flux, which contrasts with designs in which the structural segments are permeable, which would result in shorting of the flux and compromising the performance of the machine.

To form the structurally integrated hoop structure 108, the second end cap 216b can be laid down. The bottom half of segments can then be stacked atop the second end cap 216b. For example, two layers of the plurality of structural segments 106 are stacked, then nine layers of both the plurality of rim segments 204 and the plurality of cap segments 206, then two layers of the plurality of structural segments 106, then nine layers of both the plurality of rim segments 204 and the plurality of cap segments 206, and then two layers of the plurality of structural segments 106. In some embodiments, an intermediate compression of this bottom half of segments can be performed before stacking the rest of the segments. Next, the center plate 104 and hub 102 (not pictured) can be installed on top of the bottom half, along with nine layers of the plurality of cap segments 206. The top half of segments can be stacked in the same order and quantity as the bottom half of segments. In some embodiments, an intermediate compression of this top half of segments can be performed before continuing the assembly. The first end cap 216a can then be installed atop the segments to complete the structurally integrated hoop structure 108. The structurally integrated hoop structure 108 can then be compressed. While the structurally integrated hoop structure 108 is compressed, the tie bars 112 and first fastener 210a and second fastener 210b can be installed. The compression can then be released. The compression of the rotor rim structure 100 can be performed before installation of permanent magnets.

As illustrated in FIG. 2, nine layers form the plurality of rim segments 204 that are stacked in the rotor rim structure 100 between two layers forming the plurality of structural segments 106. This design rule enables a sufficient axial length (the length along the z-axis) to be made up of paramagnetic material. Although nine layers of the plurality of rim segments 204 positioned between two layers of the plurality of structural segments 106 are illustrated in FIG. 2, this is not required and some other number of layers can be utilized in assembling the rotor rim structure 100. One of ordinary skill in the art would recognize many variations, modifications, and alternatives.

FIG. 3 illustrates a zoomed-in view of an exemplary rotor rim structure 100 with laminated structural segments according to an embodiment of the present disclosure. The permanent magnets are removed from the image for clarity. FIG. 3 depicts a first set 302a of a plurality of structural segments 106 that are stacked in an offset, brick laid manner. For example, a first structural segment 106a at the bottom of the set is disposed in a first plane (i.e., an x-y plane). A second structural segment 106b is positioned adjacent to the first structural segment 106a in the first plane. A third structural segment 106c is positioned atop the first structural segment 106a and the second structural segment 106b in a second plane that is parallel to the first plane. But the placement of the third structural segment 106c is not aligned with the first structural segment 106a or the second structural segment 106b. Instead, the third structural segment 106c is circumferentially offset from the first structural segment 106a and the second structural segment 106b. This is discussed further in relation to FIG. 4 below.

FIG. 4 illustrates an exploded view of an exemplary plurality of structural segments 106 for a rotor rim structure 100 according to an embodiment of the present disclosure. As illustrated in FIG. 4, the first structural segment 106a and second structural segment 106b are disposed in a first plane (i.e., an x-y plane). The third structural segment 106c is disposed in a second plane (i.e., a plane located at a different z-axis position than the first plane) that is parallel to the first plane. The third structural segment 106c can be positioned atop the first structural segment 106a and second structural segment 106b at an offset such that the ends of the third structural segment 106c do not align with the ends of the first structural segment 106a or the second structural segment 106b. Thus, other structural segments 106 that will be positioned in the second plane adjacent to the third structural segment 106c will also be offset from the first structural segment 106a and the second structural segment 106b. Thus, end 405 of second structural segment 106b is circumferentially offset from first end 407 and second end 409 of third structural segment 106c.

Each of the plurality of structural segments 106 can include cavities within which permanent magnets can be positioned. The placement of the plurality of structural segments 106 in circumferentially offset layers can align the cavities. For example, the first structural segment 106a can include a first cavity 114a. The third structural segment 106c can include a second cavity 114b. When the third structural segment 106c is placed atop the first structural segment 106a and the second structural segment 106b, the first cavity 114a and the second cavity 114b can axially align to allow a permanent magnet to be axially inserted along the z-axis within the first cavity 114a and the second cavity 114b.

Referring back to FIG. 3, other sets of the plurality of structural segments 106 can additionally be stacked in circumferentially offset and substantially parallel arrangements. For example, a second set 302b of the plurality of structural segments 106 can include a fourth structural segment 106d and a fifth structural segment 106e positioned adjacent to one another in a third plane. The second set 302b can also include a sixth structural segment 106f that is circumferentially offset from the fourth structural segment 106d and the fifth structural segment 106e on which the sixth structural segment 106f is stacked.

As shown in FIG. 3, the seams of the first set 302a and the second set 302b are circumferentially offset. That is, the first set 302a can include a first seam 304a between the first structural segment 106a and the second structural segment 106b. The second set 302b can include a second seam 304b between the fourth structural segment 106d and the fifth structural segment 106e. The first seam 304a and the second seam 304b are circumferentially offset from one another as shown in FIG. 3. In an example, seams between sets of the plurality of structural segments 106 may be offset by 30°. The number of segments of the plurality of structural segments 106 per set, the number of sets in the rotor rim structure 100, and the axial spacing of each structural segment of the plurality of structural segments 106 can be a function of the mechanical speed of the rotor, the diameter of the rotor rim structure 100, and other operating parameters of the electromagnetic machine. In other embodiments, one or more seams are circumferentially aligned as appropriate to the particular application.

Thus, embodiments of the present invention utilize circumferential clocking of the lamination layers such that the seams do not line up continuously in order to create a “chain-link” effect. This structure can be implemented using more or less than three segments per “set” or group of laminations. For example, some applications utilize more or less than three segments per set, particularly as the diameter of the rotor rim structure increases, generally resulting in more than three segments per set.

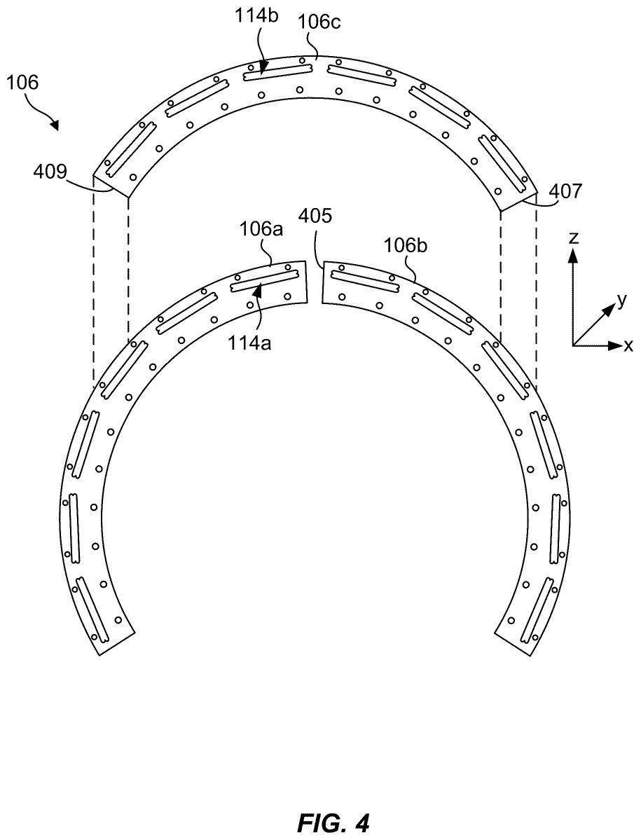

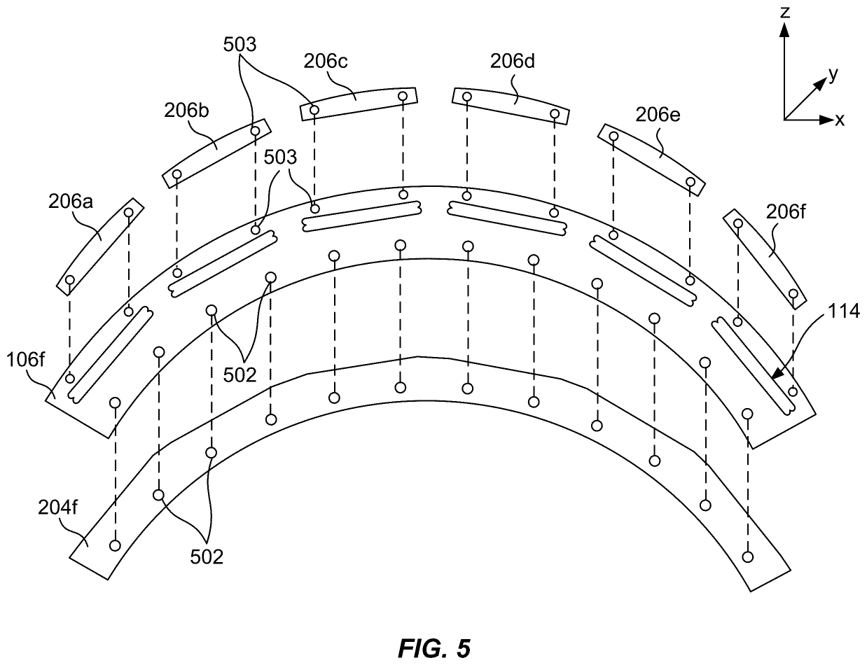

Referring once again to FIG. 3, the first set 302a of the plurality of rim segments 204 and the plurality of cap segments 206 can be positioned between the first set 302a and the second set 302b of the plurality of structural segments 106. More specifically, a first rim segment 204a, a second rim segment 204b, a third rim segment 204c, a fourth rim segment 204d, a fifth rim segment 204e, and a sixth rim segment 204f, as well as a first cap segment 206a, a second cap segment 206b, a third cap segment 206c, and a fourth cap segment 206d can be positioned atop sixth structural segment 106f. Both the plurality of rim segments 204 and the plurality of cap segments 206 can be stacked parallel to the second set 302a of the plurality of structural segments 106. The plurality of rim segments 204 can be positioned such that an outside edge of the plurality of rim segments 204 is positioned radially inward from a cavity 114 on the sixth structural segment 106f. The plurality of cap segments 206 can be positioned on a portion of the sixth structural segment 106f that is positioned radially outward from the cavity 114. This is further depicted in FIG. 5.

FIG. 5 illustrates an exploded view of an exemplary structural segment, rim segment, and cap segments for a rotor rim structure according to an embodiment of the present disclosure. As shown in the exploded view of FIG. 5, an exemplary sixth structural segment 106f, a sixth rim segment 204f, and a plurality of cap segments 206 are utilized as components of rotor rim structure 100. Referring to FIG. 5, the sixth rim segment 204f is positioned below a portion of the sixth structural segment 106f that is positioned radially inward from the cavity 114. The plurality of cap segments 206, which include first cap segment 206a, second cap segment 206b, third cap segment 206c, fourth cap segment 206d, fifth cap segment 206e, and sixth cap segment 206f, are positioned on a portion of the sixth structural segment 106f that is radially outward from the cavity 114. The sixth rim segment 204f and the plurality of cap segments 206 are positioned on opposing sides of the sixth structural segment 106f. Holes 502 formed in the sixth rim segment 204f and the sixth structural segment 106f are axially aligned. Similarly, holes 503 in the plurality of cap segments 206 and the sixth structural segment 106f are axially aligned. Tie bars can extend through the holes, i.e., holes 502 and holes 503 that are axially aligned, respectively, to axially couple the segments. The space between one of the plurality of cap segments 206 and the sixth rim segment 204f measured in the x-y plane aligns with the cavities 114.

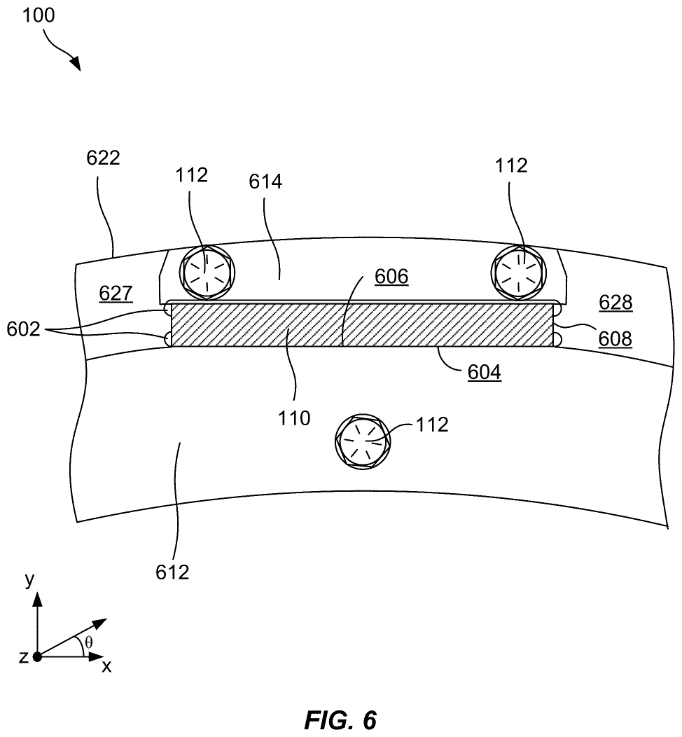

FIG. 6 illustrates a plan view of an exemplary permanent magnet 110 installed within a rotor rim structure 100 according to an embodiment of the present disclosure. The permanent magnet 110 may be retained in a salient pole configuration within cavities of a structural segment 622 of a plurality of structural segments 106, and between a rim segment 612 of a plurality of rim segments 204 and cap segment 614 of a plurality of cap segments 206 as illustrated in FIGS. 2 and 6. In this plan view diagram, the structural segment 622 is illustrated as partially transparent, only showing the portion of the structural segment 622 that is present at radial distances larger than the outside diameter of the rim segment 612, thereby illustrating the rim segment 612 that is located in a plane parallel to the structural segment 622 at positions behind or in front of the plane including the structural segment 622 shown in FIG. 6. The cap segment 614 is positioned in a plane in front of the plane including the structural segment 622.

The structural segment 622 can be fastened to others of the plurality of structural segments 106 via tie bars 112 extending axially through the rotor rim structure 100. The outer rim of the cap segment 614 can be flush with the outer rim of the structural segment 622. The inner rim of the cap segment 614 can be flush with the portion of the structural segment 622 adjacent the opening for the permanent magnet 110. The outer rim of the rim segment 612 can have a flat surface 604 that is flush with an inner surface 606 of the permanent magnet 110, thereby providing a planar surface on which the permanent magnet 110 is supported. In other embodiments, pole shaping can be utilized for the cap segment 614. One of ordinary skill in the art would recognize many variations, modifications, and alternatives.

The cavity in the structural segment 622 illustrated in FIG. 6 (i.e., one of the cavities 114 illustrated in FIG. 5) in which the permanent magnet 110 is installed can include reliefs 602, for example, formed in the corners of the cavity in the structural segment 622. Including reliefs 602 in the structural segment 622 can aid in avoiding stress concentrations in the structural segment 622. In some embodiments, the side surfaces 608 of the cavity can function to hold the permanent magnet 110 at a fixed position circumferentially on the rotor. Gaps between the permanent magnet 110 and any of the segments can be filled with potting resin.

According to some embodiments of the present invention, no ferromagnetic material is present along the axial length of the rotor rim structure 100 at locations offset from the cap segment 614. Referring to FIG. 6, at locations 627 and 628, only the structural segment 622 is present along the axial length since these locations are at greater radial distances than the outer diameter of the rim segment 612 and angularly offset (at an angle θ) from the cap segment 614. This lack of ferromagnetic material at locations 627 and 628 prevents the flux from circulating from the cap segment 614, through the permanent magnet 110, and through the rim segment 612 back to the cap segment 614. Rather, the flux will pass from the cap segment 614, through the permanent magnet 110, and radially along the rim segment 612.

FIG. 7 illustrates a cross-sectional view of an exemplary rotor rim structure 100 with laminated segments and a permanent magnet 110 according to an embodiment of the present disclosure. The permanent magnet 110 can be inserted within a space created by axially aligning cavities of plurality of structural segments 106 stacked in a substantially parallel arrangement. The permanent magnet 110 can also extend through the rotor rim structure 100 between a plurality of rim segments 204 and a plurality of cap segments 206 stacked in the rotor rim structure 100. The permanent magnet 110 can have a radial direction of magnetization. In various embodiments, spacers 702 can be used to fill gaps between the permanent magnet 110 and end caps 216.

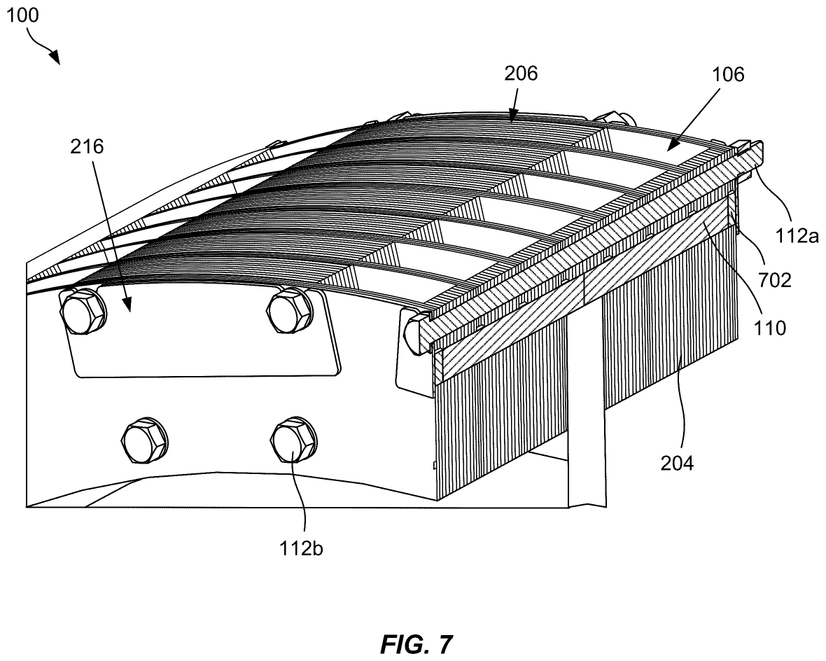

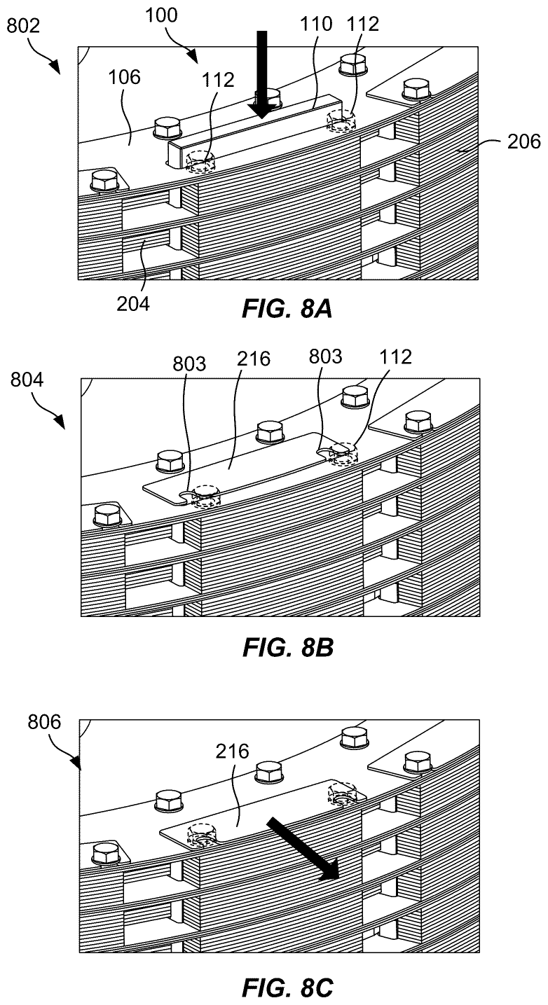

The segments can be fastened using tie bars 112a-b that extend through the stacked segments. For example, a first tie bar 112a that is closer to an outer rim of the rotor rim structure 100 can extend through end caps 216, the plurality of structural segments 106, and the plurality of cap segments 206. A second tie bar 112b that is closer to an inner rim of the rotor rim structure 100 can extend through end caps 216, the plurality of structural segments 106, and the plurality of rim segments 204. The permanent magnet 110 may be retained within the rotor rim structure by the end caps 216. In some embodiments, the end caps 216 may include a cavity through which the permanent magnet 110 can be installed. In other embodiments, such as the embodiment depicted in FIGS. 7-8, the end caps 216 may be slotted to allow for installation of the permanent magnet 110 prior to installation of the end caps 216.

FIGS. 8A-8C illustrate exemplary installation of a permanent magnet 110 into a rotor rim structure 100 with laminated segments according to an embodiment of the present disclosure. In a first step 802, a permanent magnet 110 can be inserted into a space within the rotor rim structure 100. The space can be the result of axially aligning stacks of segments. For example, cavities of a plurality of structural segments 106 can axially align to form the space. Additionally, sets of a plurality of rim segments 204 and a plurality of cap segments 206 can be stacked at a distance from one another. This distance between the plurality of rim segments 204 and plurality of cap segments 206 can axially align with the cavities of the plurality of structural segments 106 to form the space through which the permanent magnet 110 can extend. The permanent magnet 110 may be inserted into the space after tie bars 112 are installed in the rotor rim structure 100, but before end caps on the top of the rotor rim structure 100 are installed. In various embodiments, gaps between the inserted permanent magnet 110 and any of the segments can be filled in (e.g., with potting resin, spacers, shims, etc.).

In a second step 804, a slotted end cap 216 can be placed atop the rotor rim structure 100. The end cap 216 can include slots 803 that can allow the end cap 216 to slide under bolt heads of the tie bars 112. The bolt heads can be loosened. In various embodiments, the outer rim of the rotor rim structure 100 can be clamped while the bolt heads are loosened.

In a third step 806, the end cap 216 can slide under the loosened bolt heads of the tie bars 112. The bolt heads can then be tightened to compress and axially retain the permanent magnet 110 in the rotor rim structure 100.

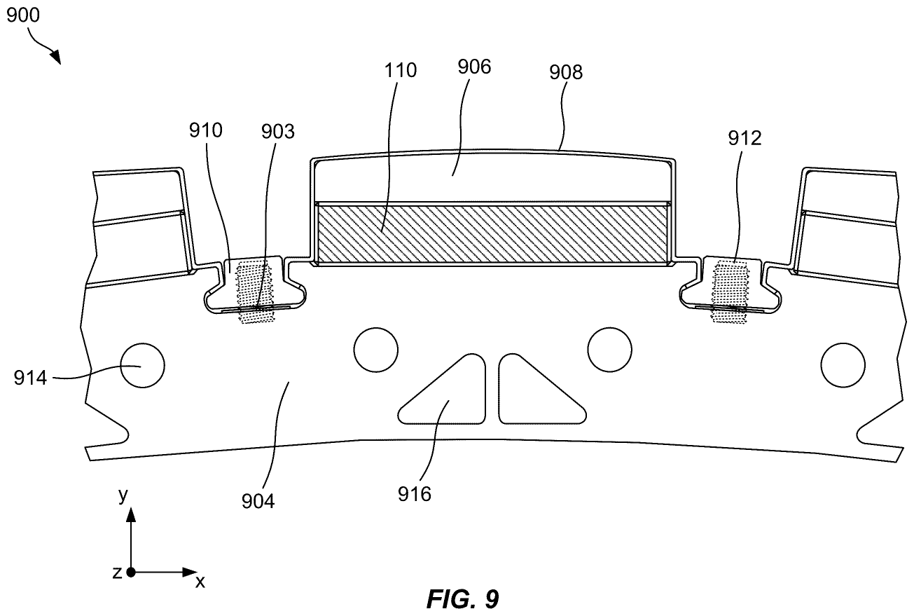

FIG. 9 illustrates a zoomed-in, plan view of an exemplary portion of a rim segment and a cap segment with wedge bars according to an embodiment of the present disclosure. The diagram 900 shown in FIG. 9 illustrates a portion of a rim segment 904 and a cap segment 906. Cap segment retains a permanent magnet 110 inserted between the rim segment 904 and the cap segment 906. The profile of the cap segment 906 can be similar to the profile of the plurality of cap segments 206 depicted in FIGS. 2-3 and 5-8. However, in the embodiment illustrated in FIG. 9, the cap segment does not include holes 502 illustrated in FIG. 5. Rather, the cap segment is joined to the plurality of structural segments (not shown) by a cover 908 as discussed below. The outer profile of the rim segment 904 is modified with respect to the rim segment 904 to include inverse dovetails 903. The rim segment 904 can also include holes 914 operable to receive threaded rods or other suitable mechanical fasteners used to form the laminated structures discussed herein. Additionally, the rim segment 904 can include lightening holes 916 to reduce the mass of the rim segment.

The portion of the rim segment 904 and the cap segment 906 shown in FIG. 9 can also include a cover 908 (e.g., a stainless steel cover) that encapsulates the permanent magnet 110, the outer rim of the cap segment 906, and the inverse dovetails 903 of the rim segment 904. Wedge bars 910 can be axially inserted into the inverse dovetails 903 of the rim segment 904.

The wedge bars 910 may be a stainless steel material and may body bound the rim segment 904. Further, the wedge bars 910 can hold the cover 908 in place with respect to the rim segment 904 and the cap segment 906. The wedge bars 910 can axially retain the illustrated segments in addition to or alternatively to tie bars. The wedge bars 910 can include a set screw 912. By axially retaining the rim segment 904 and the cap segment 906 with the wedge bars 910, alignment of the permanent magnet 110 may be improved. Use of wedge bars 910 can also simplify the design of the portion of the rim segment and the cap segment 906 and increase ease of installation. Additionally, the wedge bars 910 can increase structural integrity of the portion of the rim segment 904 and the cap segment 906 during shock or other impulse loading events where friction forces between the layers of rim segments and cap segments may be overcome.

The wedge bar 910 and the cover 908 can encapsulate the salient pole configuration of the permanent magnet 110 to retain the permanent magnet 110 onto the rotor rim structure during operational and non-operational loading conditions.

In some embodiments, the portion of the rim segment 904 and the cap segment 906 illustrated in FIG. 9 can be utilized as a substitute for the plurality of rim segments 204 and the plurality of cap segments 206 depicted in FIGS. 2-3 and 5-8. That is, a rotor rim structure may include a plurality of structural segments 106 and stacks of the rim segment 904 and the cap segment 906, as well as any other components depicted in FIGS. 9-11.

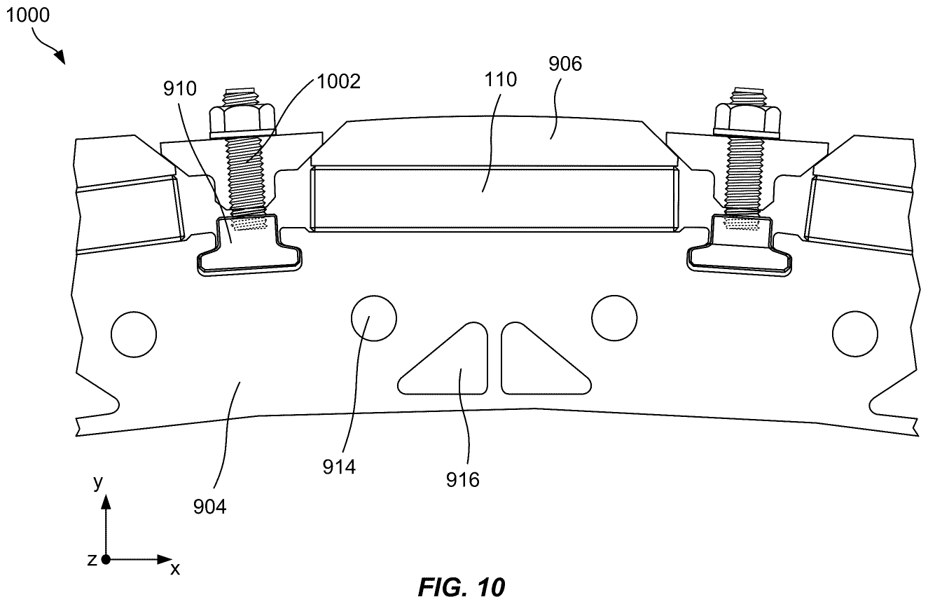

FIG. 10 illustrates a zoomed-in, plan view of the portion of the rim segment and the cap segment 906 with wedge bars 910 and tee bars 1002 according to an embodiment of the present disclosure. The diagram 1000 illustrates an embodiment in which, to actuate a wedge bar 910 against the inverse dovetail 903 of the rim segment 904, the tee bar 1002 can be screwed onto the set screw 912 of the wedge bar 910 (depicted in FIG. 9). The wedge bar 910 and the tee bar 1002 can retain the salient pole configuration of the permanent magnet 110 to retain the permanent magnet 110 onto the rotor rim structure during operational and non-operational loading conditions. In embodiments in which the cover 908 is utilized between the cap segment 906 and the tee bar 1002 and extending into the inverse dovetails 903, the tee bar 1002 screwing the tee bar 1002 onto the wedge bar 910 can further compress the cover 908 shown in FIG. 9 against the rim segment 904.

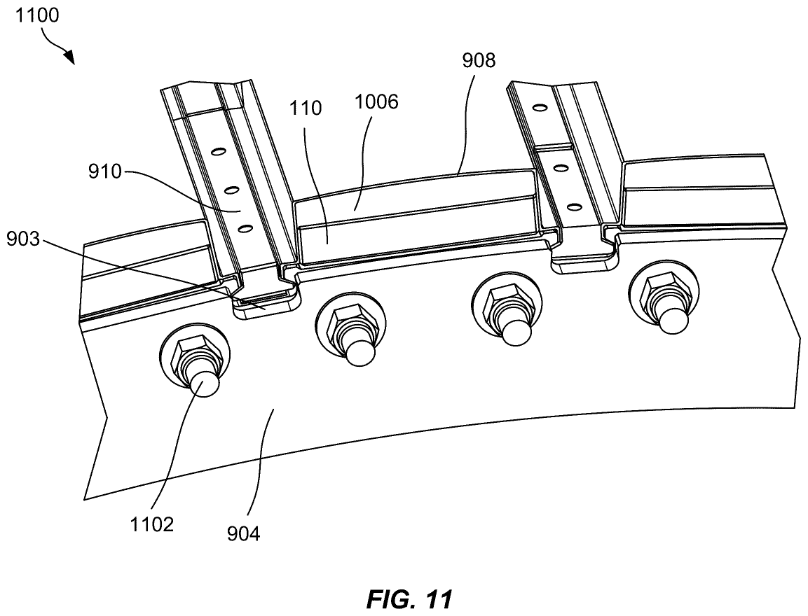

This is further depicted in FIG. 11, which illustrates a zoomed-in, perspective view of the portion of the rim segment and the cap segment 906 with wedge bars 910 according to an embodiment of the present disclosure. The tee bars are not depicted in the diagram 1100 shown in FIG. 11 for purposes of clarity. The cover 908 can compress a stack of a plurality of cap segments 1006 against a first side of the permanent magnet 110. The second side of the permanent magnet 110 can be flush with an outer edge of the rim segment 904. In various embodiments, the rim segment 904 can additionally be axially retained by threaded rods 1102 that extend through the stack of the plurality of rim segments 904.

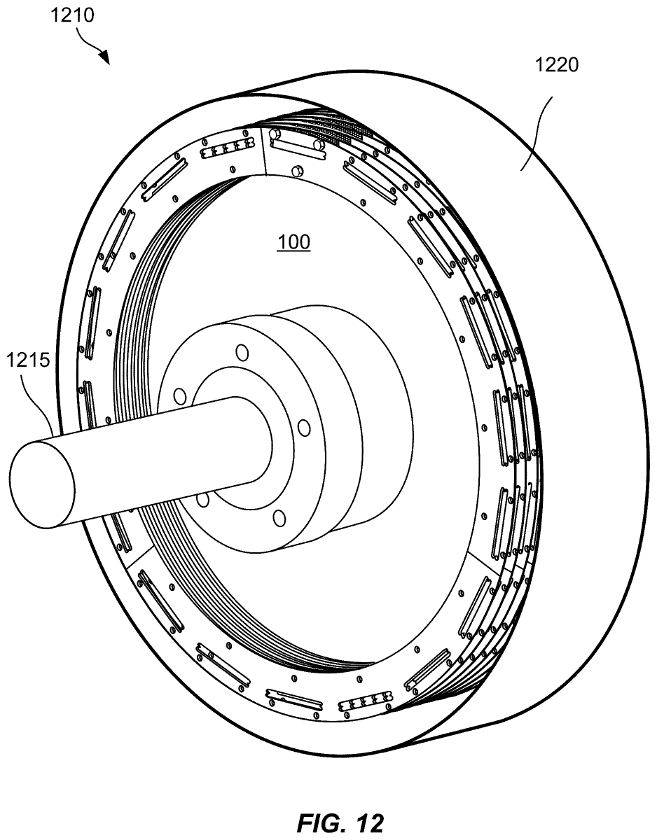

FIG. 12 is a simplified exploded view of an electromagnetic machine including a rotor rim structure with laminated structural segments according to an embodiment of the present invention. As illustrated in FIG. 12, electromagnetic machine 1210, which can also be referred to as a motor, includes rotor rim structure 100 with laminated structural segments as discussed in relation to FIG. 1. Electromagnetic machine 1210 also includes stator 1220 surrounding rotor rim structure 100 and output shaft 1215 attached to rotor rim structure 100. The description provided in relation to rotor rim structure 100 throughout this specification is applicable to the electromagnetic machine 1210 incorporating the rotor rim structure as illustrated in FIG. 12.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a rotor rim structure comprising: a plurality of structural segments, each structural segment of the plurality of structural segments having a curved profile and stacked in a substantially parallel arrangement to form a structurally integrated hoop structure; a permanent magnet retained in a salient pole configuration; and a tie bar extending axially through each structural segment of the plurality of structural segments.

Example 2 is the rotor rim structure of example 1, wherein the plurality of structural segments comprise: a first structural segment disposed in a first plane and comprising a first cavity; a second structural segment positioned adjacent to the first structural segment in the first plane; and a third structural segment positioned in a second plane parallel to the first plane, wherein: the third structural segment is circumferentially offset from the first structural segment; and the second structural segment and the third structural segment comprise a second cavity aligned with the first cavity.

Example 3 is the rotor rim structure of example(s) 1-2, further comprising: a second set of the plurality of structural segments comprising: a fourth structural segment disposed in a third plane parallel to the first plane and the second plane; and a fifth structural segment positioned adjacent to the fourth structural segment in the third plane; and a sixth structural segment positioned in a fourth plane parallel to the third plane, wherein the sixth structural segment is circumferentially offset from the fourth structural segment and the fifth structural segment, the sixth structural segment comprising a third cavity aligned with the first cavity.

Example 4 is the rotor rim structure of example(s) 1-3, wherein the permanent magnet is retained within the first cavity and the second cavity.

Example 5 is the rotor rim structure of example(s) 1-4, further comprising a plurality of rim segments stacked parallel to the plurality of structural segments, wherein an outer edge of each of the plurality of rim segments is positioned radially inward from the second cavity in the third structural segment.

Example 6 is the rotor rim structure of example(s) 1-5, wherein the plurality of rim segments comprises a ferromagnetic material.

Example 7 is the rotor rim structure of example(s) 1-6, further comprising a plurality of cap segments stacked parallel to the third structural segment, the plurality of cap segments being positioned on a portion of the third structural segment that is positioned radially outward from the second cavity.

Example 8 is the rotor rim structure of example(s) 1-7, wherein the plurality of rim segments and the plurality of cap segments comprise a carbon steel material.

Example 9 is the rotor rim structure of example(s) 1-8, wherein the plurality of structural segments comprises a 200 series stainless steel material.

Example 10 is the rotor rim structure of example(s) 1-9, wherein the plurality of structural segments comprises a non-permeable material.

Example 11 is the rotor rim structure of example(s) 1-10, wherein the non-permeable material comprises stainless steel.

Example 12 is the rotor rim structure of example(s) 1-11, wherein the stainless steel comprises a 200 series stainless steel.

Example 13 is the rotor rim structure of example(s) 1-12, wherein the permanent magnet extends through the structurally integrated hoop structure between the plurality of rim segments and the plurality of cap segments.

Example 14 is the rotor rim structure of example(s) 1-13, wherein the permanent magnet is configured to have a radial direction of magnetization.

Example 15 is the rotor rim structure of example(s) 1-14, wherein the first structural segment, the second structural segment, and the third structural segment comprise a first set of the plurality of structural segments, wherein the first set of the plurality of structural segments comprises a first seam between the first structural segment and the second structural segment in the first plane, and wherein the rotor rim structure further comprises: a second set of the plurality of structural segments comprising: a fourth structural segment disposed in a third plane parallel to the first plane and the second plane; and a fifth structural segment positioned adjacent to the fourth structural segment in the third plane.

Example 16 is the rotor rim structure of example(s) 1-15, wherein a second seam formed between the fourth structural segment and the fifth structural segment in the third plane is circumferentially offset from the first seam in the first plane.

Example 17 is the rotor rim structure of example(s) 1-16, wherein the first structural segment and a second structural segment comprise a first set of the plurality of structural segments, wherein the first set of the plurality of structural segments comprises a first seam between the first structural segment and the second structural segment in the first plane, and wherein the rotor rim structure further comprises: a second set of the plurality of structural segments comprising: a third structural segment disposed in a third plane parallel to the first plane and the second plane; and a fourth structural segment positioned adjacent to the fourth structural segment in the third plane.

Example 18 is the rotor rim structure of example(s) 1-17, wherein a second seam is circumferentially offset from the first seam in the first plane.

Example 19 is the rotor rim structure of example(s) 1-18, further comprising: a first fastener attached on a first end of the tie bar; and a second fastener attached on a second end of the tie bar to axially couple the plurality of structural segments together on the tie bar.

Example 20 is the rotor rim structure of example(s) 1-19, further comprising: a first end cap fastened to a first end of the permanent magnet; and a second end cap fastened to a second end of the permanent magnet to axially retain the permanent magnet in the rotor rim structure with the first end cap.

Example 21 is the rotor rim structure of example(s) 1-20, further comprising a wedge bar coupled to an outer edge of a plurality of rim segments, wherein the wedge bar is body bounded by the plurality of rim segments.

Example 22 is the rotor rim structure of example(s) 1-21, further comprising a tee bar coupled to the wedge bar.

Example 23 is an electromagnetic machine comprising: a stator; a rotor rim structure electrically coupled to the stator and including: a plurality of structural segments, each structural segment of the plurality of structural segments having a curved profile and stacked in a substantially parallel arrangement to form a structurally integrated hoop structure; a plurality of rim segments stacked parallel to the plurality of structural segments; a plurality of cap segments stacked parallel to the plurality of structural segments; and a permanent magnet retained in a salient pole configuration; and an output shaft mechanically coupled to the rotor rim structure.

Example 24 is the electromagnetic machine of example 23 further comprising: a tie bar extending axially through each structural segment of the plurality of structural segments; a first fastener attached on a first end of the tie bar; and a second fastener attached on a second end of the tie bar to axially couple the plurality of structural segments together on the tie bar.

Example 25 is the electromagnetic machine of example(s) 23-24, wherein the plurality of structural segments comprise: a first structural segment disposed in a first plane and comprising a first cavity; a second structural segment positioned adjacent to the first structural segment in the first plane; a third structural segment positioned in a second plane parallel to the first plane; a fourth structural segment disposed in a third plane parallel to the first plane and the second plane; and a fifth structural segment positioned adjacent to the fourth structural segment in the third plane; and a sixth structural segment positioned in a fourth plane parallel to the third plane, wherein: the third structural segment is circumferentially offset from the first structural segment; the second structural segment and the third structural segment comprise a second cavity aligned with the first cavity; and the sixth structural segment is circumferentially offset from the fourth structural segment and the fifth structural segment, the sixth structural segment comprising a third cavity aligned with the first cavity.

Example 26 is the electromagnetic machine of example(s) 23-25, wherein the permanent magnet is retained within the first cavity and the second cavity.

Example 27 is the electromagnetic machine of example(s) 23-26, wherein: an outer edge of each of the plurality of rim segments is positioned radially inward from the second cavity in the third structural segment; and the plurality of cap segments are positioned on a portion of the third structural segment that is positioned radially outward from the second cavity.

Example 28 is the electromagnetic machine of claim 25, wherein: a first seam is present between the first structural segment and the second structural segment in the first plane; a second seam is present between the fourth structural segment and the fifth structural segment in the third plane; and the first seam is circumferentially offset from the second seam.

Example 29 is the electromagnetic machine of example(s) 23-28, wherein: the plurality of structural segments comprises stainless steel; and the plurality of rim segments and the plurality of cap segments comprises a ferromagnetic material.

Example 30 is the electromagnetic machine of example(s) 23-29, wherein the permanent magnet extends through the structurally integrated hoop structure between the plurality of rim segments and the plurality of cap segments.

Example 31 is the electromagnetic machine of example(s) 23-30, wherein the permanent magnet is configured to have a radial direction of magnetization.

Example 32 is the electromagnetic machine of example(s) 23-31, further comprising: a first end cap fastened to a first end of the permanent magnet; and a second end cap fastened to a second end of the permanent magnet to axially retain the permanent magnet in the rotor rim structure with the first end cap.

The above description of exemplary embodiments of the disclosure has been presented for the purposes of illustration and description. It is not intended to be exhaustive or to limit the disclosure to the precise form described, and many modifications and variations are possible in light of the teaching above. The embodiments were chosen and described in order to best explain the principles of the disclosure and its practical applications to thereby enable others skilled in the art to best utilize the disclosure in various embodiments and with various modifications as are suited to the particular use contemplated.

All publications, patents, and patent applications cited herein are hereby incorporated by reference in their entirety for all purposes.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered.

What is claimed is:

1. A rotor rim structure comprising:
a plurality of structural segments, each structural segment of the plurality of structural segments having a curved profile and stacked in a substantially parallel arrangement to form a structurally integrated hoop structure;
a permanent magnet retained in a salient pole configuration; and
a tie bar extending axially through each structural segment of the plurality of structural segments.

2. The rotor rim structure of claim 1, wherein the plurality of structural segments comprise:
a first structural segment disposed in a first plane and comprising a first cavity;
a second structural segment positioned adjacent to the first structural segment in 4 the first plane; and
a third structural segment positioned in a second plane parallel to the first plane, wherein:
the third structural segment is circumferentially offset from the first structural segment;
and the second structural segment and the third structural segment comprise a second cavity aligned with the first cavity.

3. The rotor rim structure of claim 2, further comprising:
a second set of the plurality of structural segments comprising:
a fourth structural segment disposed in a third plane parallel to the first plane and the second plane; and
a fifth structural segment positioned adjacent to the fourth structural segment in the third plane; and
a sixth structural segment positioned in a fourth plane parallel to the third plane, wherein the sixth structural segment is circumferentially offset from the fourth structural segment and the fifth structural segment, the sixth structural segment comprising a third cavity aligned with the first cavity.

4. The rotor rim structure of claim 2, wherein the permanent magnet is retained within the first cavity and the second cavity.

5. The rotor rim structure of claim 2, further comprising a plurality of rim segments stacked parallel to the plurality of structural segments, wherein an outer edge of each of the plurality of rim segments is positioned radially inward from the second cavity in the third structural segment.

6. The rotor rim structure of claim 5, wherein the plurality of rim segments comprises a ferromagnetic material.

7. The rotor rim structure of claim 5, further comprising a plurality of cap segments stacked parallel to the third structural segment, the plurality of cap segments being positioned on a portion of the third structural segment that is positioned radially outward from the second cavity.

8. The rotor rim structure of claim 7, wherein the plurality of rim segments and the plurality of cap segments comprise a carbon steel material.

9. The rotor rim structure of claim 7, wherein the permanent magnet extends through the structurally integrated hoop structure between the plurality of rim segments and the plurality of cap segments.

10. The rotor rim structure of claim 9, wherein the permanent magnet is configured to have a radial direction of magnetization.

11. The rotor rim structure of claim 5, wherein the plurality of structural segments comprises a 200 series stainless steel material.

12. The rotor rim structure of claim 2, wherein the first structural segment, the second structural segment, and the third structural segment comprise a first set of the plurality of structural segments, wherein the first set of the plurality of structural segments comprises a first seam between the first structural segment and the second structural segment in the first plane, and wherein the rotor rim structure further comprises:
a second set of the plurality of structural segments comprising:
a fourth structural segment disposed in a third plane parallel to the first plane and the second plane; and
a fifth structural segment positioned adjacent to the fourth structural segment in the third plane.

13. The rotor rim structure of claim 12, wherein a second seam formed between the fourth structural segment and the fifth structural segment in the third plane is circumferentially offset from the first seam in the first plane.

14. The rotor rim structure of claim 13, wherein a second seam is circumferentially offset from the first seam in the first plane.

15. The rotor rim structure of claim 2, wherein the first structural segment and a second structural segment comprise a first set of the plurality of structural segments, wherein the first set of the plurality of structural segments comprises a first seam between the first structural segment and the second structural segment in the first plane, and wherein the rotor rim structure further comprises:
a second set of the plurality of structural segments comprising:
a third structural segment disposed in a third plane parallel to the first plane and the second plane; and
a fourth structural segment positioned adjacent to the fourth structural segment in the third plane.

16. The rotor rim structure of claim 1, wherein the plurality of structural segments comprises a non-permeable material.

17. The rotor rim structure of claim 16, wherein the non-permeable material comprises stainless steel.

18. The rotor rim structure of claim 17, wherein the stainless steel comprises a 200 series stainless steel.

19. The rotor rim structure of claim 1, further comprising:
a first fastener attached on a first end of the tie bar, and a second fastener attached on a second end of the tie bar to axially couple the plurality of structural segments together on the tie bar.

20. The rotor rim structure of claim 1, further comprising:
a first end cap fastened to a first end of the permanent magnet; and
a second end cap fastened to a second end of the permanent magnet to axially retain the permanent magnet in the rotor rim structure with the first end cap.
